(19) United States
(12) Patent Application Publication
(10) Pub. No.: US 2006/0027006 A1
(43) Pub. Date: Feb. 9, 2006

(54) Key stop positioning system

(76) Inventor: Thomas J. Di Vito, Southington, CT (US)

Correspondence Address: Jennifer A. Calcagni;Carmody & Torrance LLP, P.O. Box 1110, 50 Leavenworth Street, Waterbury, CT, 06721-1110, US

(21) Appl. No.: 10/912,380

(22) Filed: Aug. 5, 2004

(51) Int. Cl. E05B 27/04; E05B 19/06

(52) U.S. Cl. 70/493; 70/409

(57) ABSTRACT

An improved cylinder lock and key combination is provided. The lock comprises a housing having a lock cylinder comprising a plurality of pin chambers each having a movable tumbler pin disposed therein, a plug rotatably mounted in the lock cylinder that comprises a key channel for receiving a portion of the key, and an interfering means positioned in the key channel. The key contains a blade portion having a plurality of cuts formed in a side of the blade. Each of the plurality of cuts are respectively alignable with each of the plurality of tumbler pins. The blade portion further comprises a key stop for correctly positioning the key in the key channel. When the key is positioned in the lock so that the key stop engages the interfering means in the key channel, the plurality of cuts on the key are aligned with the plurality of tumbler pins to create a shear line that allows operation of the lock.

### FIELD OF THE INVENTION

The present invention is directed to a cylinder lock/key combination for providing limited distribution of keys with a high level of security in a cost-effective manner.

### BACKGROUND OF THE INVENTION

Key blanks and their corresponding cylinders are produced with consistent tolerances so that the lock industry has standard measures and methods to ensure mass key cutting and duplication by retail outlets. The top few keyway profiles provide security for the majority of all residential and commercial security doors.

Locks and keys with limited distribution provide a higher level of security as they cannot be duplicated except where authorized. Typically, this is done in part with novel keyway profiles and other unique features. These products are generally referred to as high security locks and keys and are well established using this limited distribution.

However, these features usually add a significant level of complexity and cost and are generally not affordable by the majority of consumers. For example, U.S. Pat. No. 5,778,712 to Walldén, describes one version of a high security lock in which a hole is provide in the key for receiving a slot-carried element in the plug as the key is inserted into the lock.

One of the critical tolerances between the key and the lock is the position of the key longitudinally inside the lock so that the cuts on the key align precisely under the appropriate bottom (tumbler) pins to allow the key to be rotated. Typically, a stop position on the key corresponds to the stop on the face or the back of a plug to achieve the correct alignment. The positioning of the cuts on the key is usually done by first locating the stop on a key against an established position on a key cutting machine. In this fashion, a duplicate key can be cut to operate a lock without having the original key or without tracing the original.

The stop on the key is designed to position the cuts on a key blade longitudinally to cooperate directly with the pins or discs of the key cylinder. The stop is generally a flat surface that meets the flat surface of the plug face or the plug retainer. The stop is normally consistent so that all keys of a certain type can be mass-produced and cut in the field with consistent accuracy.

U.S. Pat. No. 4,196,605 to Garza, the subject matter of which is herein incorporated by reference in its entirety, describes a typical cylinder lock having a stop position at the back of the plug to achieve alignment. The lock cylinder comprises a conical depression that cooperates with a pointed element at the inner end of a key. U.S. Pat. No. 5,758,526 to Gorokhovsky, describes another variation of a key stop positioned at the back of the plug.

European Patent No. EP 0 637 663 B1 to Kaba Gege GmbH, the subject matter of which is herein incorporated by reference in its entirety describes a typical key stop positioned at the front of the plug. The depth to which the key can be inserted into the lock is fixed by means of projections arranged on a stop boss at the top of the key blade that engage a recess of the cylinder core, or, in the alternative, the recess in the stop boss is provided for receiving a projection of the cylinder core.

U.S. Pat. No. 5,493,884 to Hinz et al., describes a variation of a key stop positioned at the front of the plug. The key stop limits the depth of insertion of the key and is disposed in the waist region of the key. The key stop is constructed as a square body which is inserted or clamped in a round recess present in the waist region of the shaft of the key or as a throughbolt that protrudes on both sides of the key.

While various key stops have been presented in the prior art, there remains a need in the art for additional cylinder lock and key combinations that can provide limited distribution of keys yet with a high level of security and in a cost effective manner.

The present invention is directed to a novel key stop for use in a cylinder lock and key combination. The keyway of the plug is designed to contain a variable position stop that corresponds with a variable milling in the key blade at an exact location so that the tumbler pins in the lock align with the cuts on the key.

While key stops in the keyway of the plug have been suggested in the prior art, their use has been limited to blocking non-conforming keys from entering the lock. In contrast to the present invention, the stops in the keyways of the prior art are not designed to orientate a key in the lock to align a plurality of cuts on the key with corresponding tumbler pins in the lock to allow operation of the lock. For example, U.S. Pat. No. 5,176,015 to Sussina, the subject matter of which is herein incorporated by reference in its entirety, describes the use of a warding pin to block entry of keys that are not grooved from the key tip to the pin position. However, these keys are only grooved so that they may pass the ward pin or pins. There is no suggestion that the ward pin can be used to align the plurality of cuts on the key with corresponding tumbler pins in the lock to orientate the key in the lock.

Another variation is described in U.S. Pat. No. 6,477,875 to Field et al., in which the key blade has a stop, which contacts a projection of a slider that slides in the lock cylinder and is separate from the tumblers. However, this key stop is designed to function in conjunction with the slider and does not function in the same manner as the key stop of the present invention.

The present invention makes it simple for most lock outlets to provide unique keys and cylinders with limited distribution but with a straightforward and simple process.

### SUMMARY OF THE INVENTION

Therefore it is an object of the present invention to provide a cylinder lock/key combination for providing limited distribution of keys.

Another objective of the present invention is to provide a cylinder lock/key combination wherein the key comprises a key stop that engages a corresponding interfering means in the key channel of the lock to properly position the key in the key channel, so that a plurality of cuts on the key are aligned with a plurality of tumbler pins in the key channel to create a shear line and allow operation of the lock.

Accordingly the present invention is directed to an improved cylinder lock and key combination,

wherein the lock comprises:
a housing;
a lock cylinder in the housing, the lock cylinder comprising:
a plurality of pin chambers each having a movable tumbler pin disposed therein;
a plug rotatably mounted in the lock cylinder, the plug comprising a key channel for receiving a portion of the key; and
an interfering means positioned in the key channel;

wherein the key comprises:
a blade portion comprising:
   a plurality of cuts formed in a side of the blade portion, wherein the each of the plurality of cuts are respectively alignable with each of the plurality of tumbler pins; and
   a key stop for correctly positioning the key in the key channel;

wherein when the key is positioned in the key channel so that the key stop engages the interfering means in the key channel, the plurality of cuts are aligned with the plurality of tumbler pins to allow operation of the lock.

### BRIEF DESCRIPTION OF THE DRAWINGS

For a fuller understanding of the invention, reference is had to the following description taken in connection with the accompanying figures, in which:

FIG. 1 is a cross section side view of a lock demonstrating a key in a cylinder prepared for completion, all in accordance with the present invention.

FIG. 2 is a cross section front view of a cylinder of the prior art with the key removed.

FIG. 3 is a cross section front view of a cylinder with the key removed and a stop pin inserted in accordance with the present invention.

FIG. 4 is a cross section side view of a lock and key combination in accordance with the present invention, demonstrating a modified key in the cylinder with a stop pin inserted.

FIG. 5 is a cross section side view of the lock of the invention demonstrating a standard prior art key in the cylinder with the stop pin inserted.

FIG. 6 is a cross section front view of the cylinder of the lock of the invention with the key removed and the keyway profile partially removed by milling from the front.

FIG. 7 is a cross section side view of the lock and key combination in accordance with the present invention with a modified key and a keyway profile partially removed by milling from the front.

FIG. 8 is a cross section side view of a lock and key combination in accordance with the present invention, demonstrating the modified key in the cylinder with the keyway profile partially removed by milling.

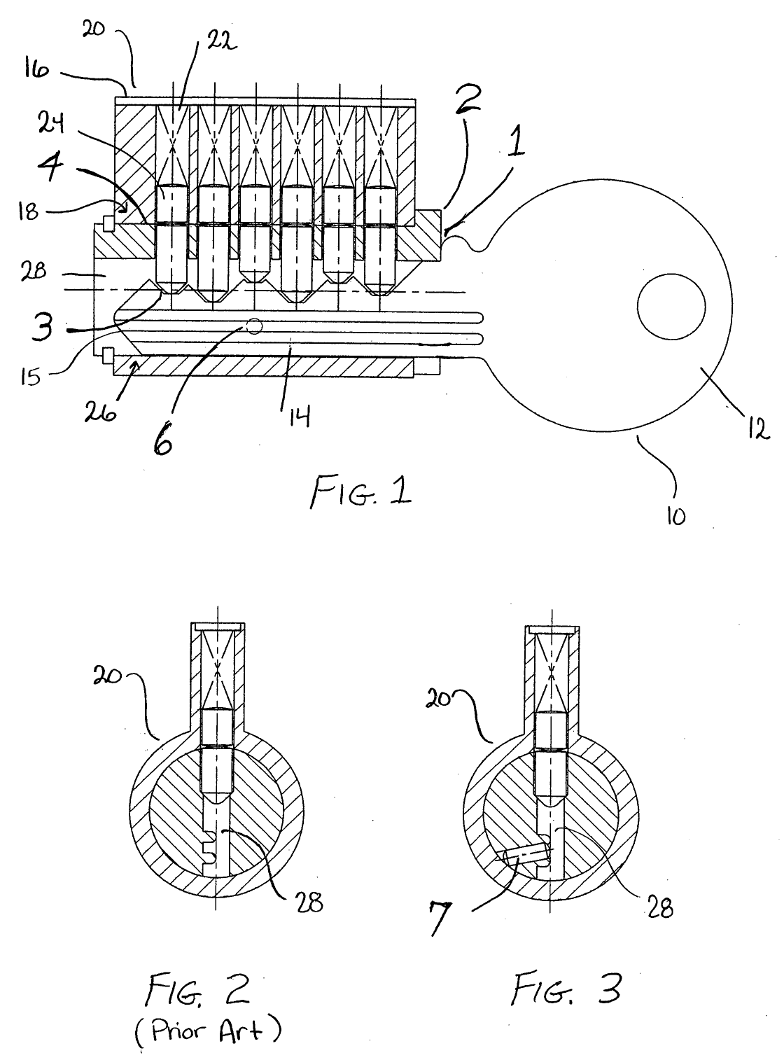

Also, while not all elements are labeled in each figure, all elements with the same reference number indicate similar or identical parts.

### DETAILED DESCRIPTION OF THE PREFERRED EMBODIMENTS

The present invention is directed to an improved cylinder lock and key combination. As depicted in the figures, the lock 20 of the invention typically comprises a housing 16 having a lock cylinder, generally indicated at 18, contained therein. For simplicity, a standard key in a lever-style pin tumbler chamber is used to illustrate the preferred attributes of the invention.

The lock cylinder 18 comprises a plurality of pin chambers 22 each having a spring-loaded movable tumbler pin 24 disposed therein, a plug, generally indicated at 26, rotatably mounted in the lock cylinder 18 that comprises a key channel 28 for receiving a portion of the key 10, and an interfering means positionable in the key channel 28.

The key 10 comprises a grip portion 12 and a blade portion 14. The blade portion comprises two opposing surfaces and a plurality of cuts 3 formed in a side of the blade portion 14. When the key 10 is positioned correctly in the key channel 28, each of the plurality of cuts 3 are respectively alignable with one of the plurality of tumbler pins 24. As depicted in FIG. 4, the blade portion 14 comprises a key stop 5 for correctly positioning the key 10 in the key channel 28 of the plug 26. The key stop 5 is generally created by removing material of the key on the blade portion 14 to create a groove 8 extending from the tip 15 of the key 10 (or a region near the tip 15) to a selected stop point. The end of the groove 8 creates the key stop 5. Preferably, the remaining blade portion 14 of the key is left untouched.

When the key 10 is positioned in the key channel 28 so that the key stop 5 engages the interfering means in the key channel 28, the plurality of cuts 3 are aligned with the plurality of tumbler pins 24 to create a shear line 4 to allow operation of the lock 20. A key 10 that does not have the exact amount of material removed longitudinally to create the key stop 5 will either not enter the key cylinder 28 fully or will enter the key cylinder 28 too far. In either case, the cuts 3 on the blade portion 14 of the key 10 will not align the tumbler pins 24 to create the shear line 4 and will therefore not allow operation of the lock.

FIGS. 4 and 5 demonstrate the operation of the lock 20 of the invention. FIG. 4 depicts a lock 20 within which a key 10 of the invention is disposed. The key 10 has a key stop 5 that engages a blocking pin 7 disposed in the key channel 28. As seen in FIG. 4, only when the key stop 5 engages the blocking pin 7 do the plurality of cuts 3 on the key 10 align with the plurality of tumbler pins 24 to create a shear line 4 and allow operation of the lock 20. In contrast, the key placed in the lock of FIG. 5 does not have a key stop that allows the key to penetrate the key channel to the correct depth so that the plurality of cuts 3 on the key 10 can be aligned with the plurality of tumbler pins 24.

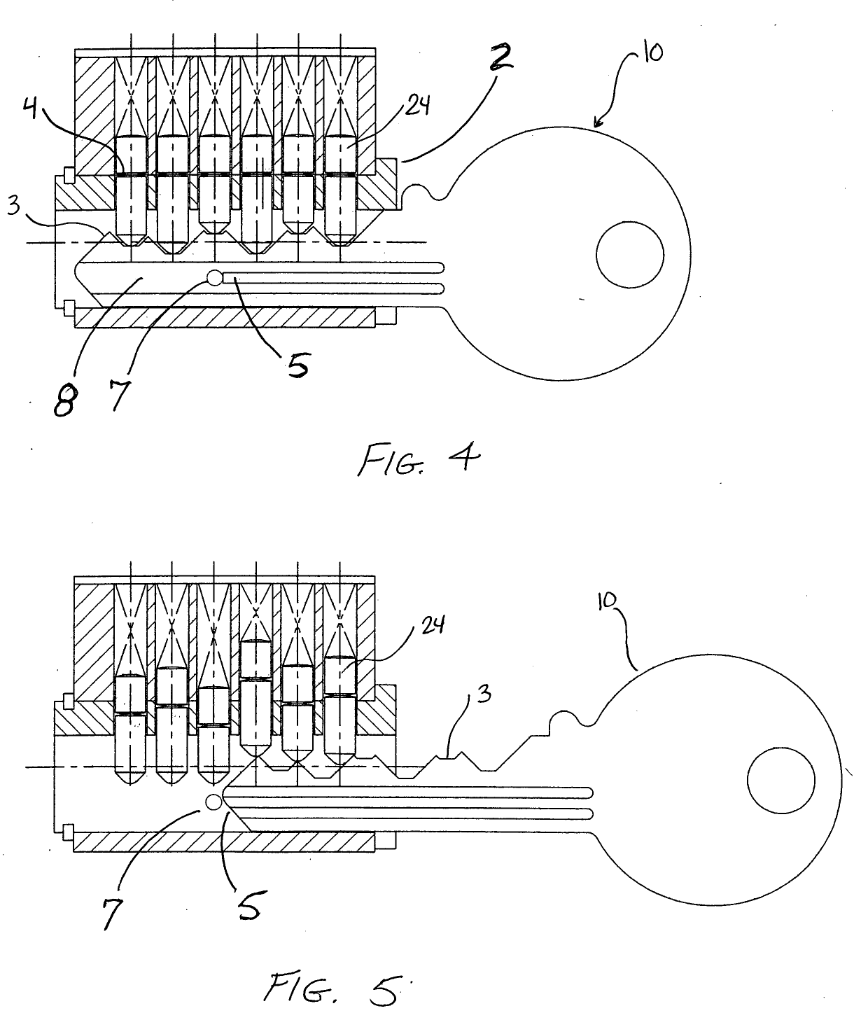

As best seen in FIG. 3, in one embodiment of the invention, the interfering means comprises a stop 7 that is placed at a selected position in the key channel 28 of the plug 26. In contrast, a conventional lock cylinder (depicted in FIG. 2) does not contain the blocking pin. The stop 7 in the key channel 28 of the plug 26 can be formed by drilling axially into the plug 26 to create an opening 6 and inserting a blocking pin 7 to reach into the key channel 28. In a preferred embodiment, the blocking pin 7 is press fit into the opening 6 in the plug 26. The key stop 5 on the key 10 engages the blocking pin 7 in the key channel 28 so that the tumbler pins 24 are aligned with the cuts 3 on the blade portion 14 of the key 10.

As seen in the figures, the key channel 28 of the plug 26 is generally grooved longitudinally from a first end 32 of the key channel 28 to a second end 34 of the key channel 28 that receives the portion of the key 10 so that the key channel 28 corresponds to the shape of the key 10.

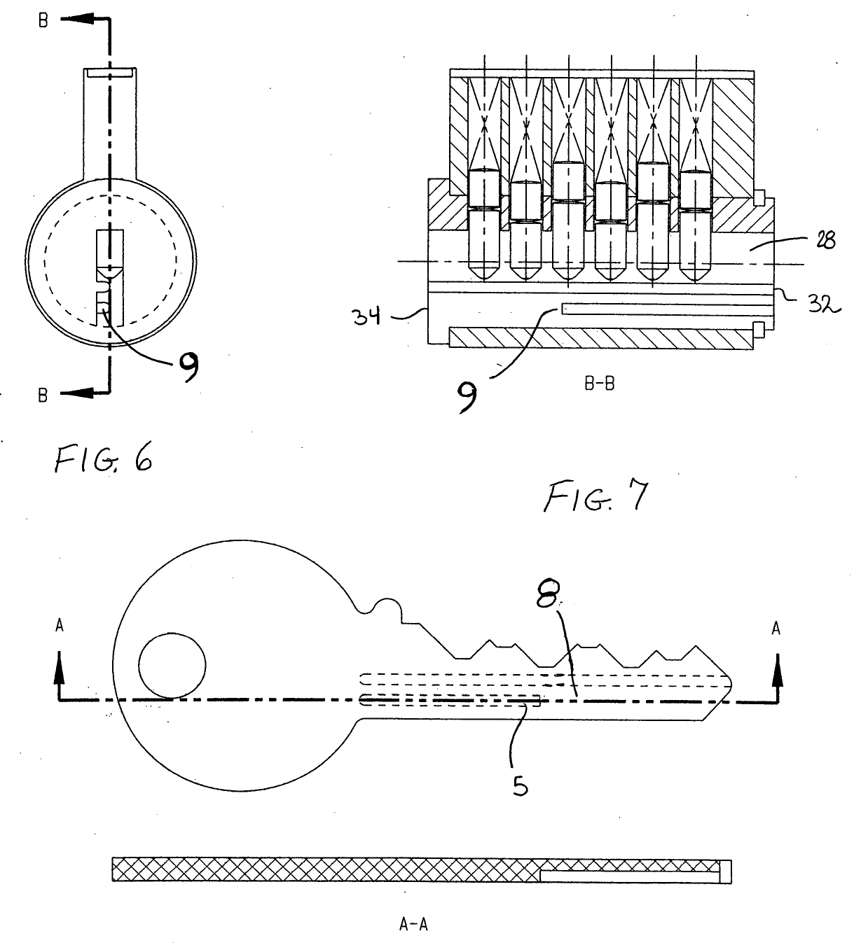

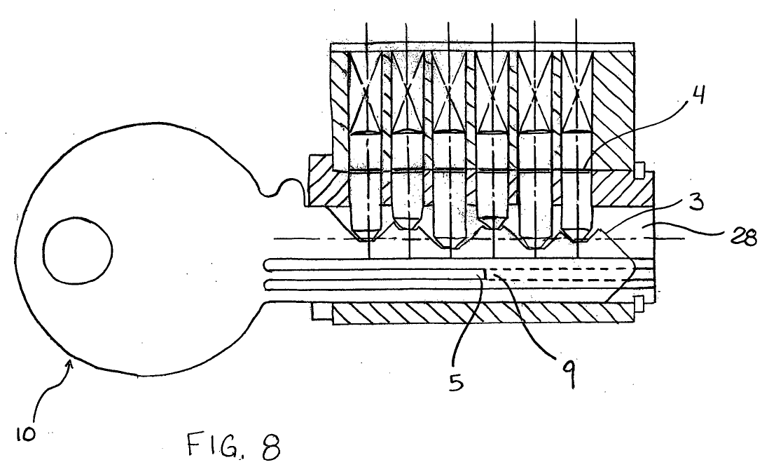

In another embodiment of the invention (FIGS. 6-8), the interfering means in the key channel 28 comprises a rib 9 extending from the first end 32 of the key channel 28 to a stop point in the key channel 28. When the key 10 is inserted into the key channel 28, the rib 9 in the key channel 28 engages the key stop 5 on the key 10 to align the plurality of cuts 3 with the plurality of tumbler pins 24 to allow operation of the lock 20.

FIG. 8 depicts the operation of this embodiment the invention, wherein the key 10 is inserted in the key channel 28 of the lock 20 so that the key stop 5 engages the rib 9 in the key channel 28 to allow the tumbler pins 24 to align with the plurality of cuts 3 on the key 10 to create a shear line 4.

One of the benefits of the present invention is that the key stop 5 and engaging interfering means (7 or 9) in the key channel 28 are positionable at any longitudinal position within the key channel 28.

The shape and the configuration of the key stop 5 and the interfering means (7 or 9) can be varied as well. For example, the key stop 5 and interfering means (7 or 9) may be designed to have complementary inverse mating shapes. Furthermore the key stop 5 may comprise one or more projections and/or indentations (not shown) that precisely mate with corresponding projections and indentations (not shown) on the interfering means (7 or 9).

The lock 20 of the invention may optionally contain an additional key stop or stop location. In one embodiment, an additional stop location 2 may be positioned at the second end 34 (opening) of the key channel 28, such that the stop location 2 at the second end 34 of the key channel 28 engages a second key stop 1 on the key 10 located between the blade portion 14 and a grip portion 12 of the key 10. The stop location 2 positioned at the second end 34 of the key channel 28 may be designed to be of a non-standard size or a non-standard shape. The stop location 2 mates with the second key stop 1. The profile of the stop location 2 and the second key stop 1 may also comprise one or more projections or indentations (not shown) that precisely mate with each other.

In another embodiment the lock 20 of the invention further comprises an additional key stop (not shown) positioned at the first end 32 of the key channel 28, which engages the tip 15 of the blade 14 when the portion of the key 10 is positioned in the key channel 28.

The key channel of the lock of the invention may also contain multiple interfering means that engage multiple key stops to further provide security in the lock.

1. A cylinder lock and key combination,
wherein the lock comprises:
a housing;
a lock cylinder in the housing, the lock cylinder comprising:
a plurality of pin chambers each having a movable tumbler pin disposed therein;
a plug rotatably mounted in the lock cylinder, the plug comprising a key channel for receiving a portion of the key; and
an interfering means having a first end that is contactable with a key positionable in the key channel and a second end extending into the plug in a direction opposite from the first end;
wherein the key comprises:
a blade portion comprising:
a plurality of cuts formed in a side of the blade portion, wherein the each of the plurality of cuts are respectively alignable with one of the plurality of tumbler pins; and
a key stop for positioning the key in the key channel of the plug;
wherein when the key is positioned in the key channel so that the key stop engages the interfering means in the key channel, the plurality of cuts on the key are aligned with the plurality of tumbler pins to allow operation of the lock.

2. The lock and key combination according to claim 1, wherein the key stop is created by milling a groove into the blade portion of the key extending from a tip of the key to a selected stop point.

3. (canceled)

4. The lock and key combination according to claim 1, wherein the interfering means is a stop pin that is press fitted into an opening created in the plug.

5. (canceled)

6. The lock and key combination according to claim 1, wherein the key stop and the engaging interfering means are positionable at any longitudinal position within the key channel.

7. The lock and key combination according to claim 1, wherein the key stop and the end of the interfering means contactable with the key each comprise a non-linear shape.

8. The lock and key combination according to claim 7, wherein the interfering means is shaped to mate with the non-linear shape of the key stop.

9. The lock and key combination according to claim 1, wherein the key channel comprises a stop location located at an opening of the key channel and the key comprises a protrusion located between the blade portion and the grip portion that is engageable with the stop location.

10. The lock and key combination according to claim 9, wherein the stop location at the opening of the key channel is shaped to mate with the protrusion on the key.

11. (canceled)

12. A key for use in a lock comprising a housing, a lock cylinder in the housing, the lock cylinder comprising a plurality of pin chambers each having a movable tumbler pin disposed therein, a plug rotatably mounted in the lock cylinder, the plug comprising a key channel for receiving a portion of the key, and an interferer positioned in the plug and having an end that extends into the key channel and being contactable with a key positionable in the key channel;
wherein the key comprises:
a blade portion comprising:
a plurality of cuts formed in a side of the blade portion, wherein the each of the plurality of cuts are respectively alignable with one of the plurality of tumbler pins; and
a key stop for positioning the key in the key channel of the plug;
wherein when the key is positioned in the key channel so that the key stop engages the interferer, the plurality of cuts on the key are aligned with the plurality of tumbler pins to allow operation of the lock.

13. A cylinder lock and key combination,
wherein the lock comprises:
a housing;
a lock cylinder in the housing, the lock cylinder comprising:
a plurality of pin chambers each having a movable tumbler pin disposed therein;
a plug rotatably mounted in the lock cylinder, the plug comprising a key channel for receiving a portion of the key, and a blocking pin positioned in the plug and having an end that extends into the key channel and being contactable with a key positionable in the key channel; and
wherein the key comprises:
a blade portion comprising:
a plurality of cuts formed in a side of the blade portion, wherein the each of the plurality of cuts are respectively alignable with one of the plurality of tumbler pins; and
a key stop for positioning the key in the key channel of the plug;
wherein when the key is positioned in the key cylinder so that the blocking pin in the key channel engages the key stop on the key, the plurality of cuts on the key are aligned with the plurality of tumbler pins to allow operation of the lock.

14. A cylinder lock and key combination,
wherein the lock comprises:
a housing;
a lock cylinder in the housing, the lock cylinder comprising:
a plurality of pin chambers each having a movable tumbler pin disposed therein;
a plug rotatably mounted in the lock cylinder, the plug comprising a key channel for receiving a portion of the key, wherein the key channel is grooved longitudinally from a first end of the key channel to a second end of the key channel that receives the portion of the key; and
a rib positioned in the key channel and extending from the first end of the key channel to a stop point in the key channel, wherein the end of the rib that corresponds to the stop point in the key channel is non-linear,
wherein the key comprises:
a blade portion comprising:
a plurality of cuts formed in a side of the blade portion, wherein the each of the plurality of cuts are respectively alignable with one of the plurality of tumbler pins; and
a key stop for positioning the key in the key channel of the plug, wherein the key stop is non-linear and is shaped to mate with the non-linear end of the rib;
wherein when the key is positioned in the key channel so that the non-linear end of the rib mates with the non-linear key stop, the plurality of cuts on the key are aligned with the plurality of tumbler pins to allow operation of the lock.

15. A cylinder lock and key combination,
wherein the lock comprises:
a housing;
a lock cylinder in the housing, the lock cylinder comprising:
a plurality of pin chambers each having a movable tumbler pin disposed therein;
a plug rotatably mounted in the lock cylinder, the plug comprising a key channel for receiving a portion of the key, wherein the key channel is grooved longitudinally from a first end of the key channel to a second end of the key channel that receives the portion of the key;
a rib positioned in the key channel and extending from the first end of the key channel to a stop point in the key channel; and
a stop location located at the second end of the key channel;
wherein the key comprises:
a blade portion comprising:
a plurality of cuts formed in a side of the blade portion, wherein the each of the plurality of cuts am respectively alignable with one of the plurality of tumbler pins;
a first key stop for positioning the key in the key channel of the plug, said first key stop engageable with the interfering means in the key channel; and
a protrusion located between the blade portion and the grip portion of the key that is engageable with the stop location at the end of the key channel;
wherein when the key is positioned in the key channel so that the rib in the key channel engages the first key stop, and the stop location at the end of the key channel engages the protrusion on the key, the plurality of cuts on the key are aligned with the plurality of tumbler pins to allow operation of the lock.
